(19) United States
(12) Patent Application Publication
(10) Pub. No.: US 2004/0095872 A1
(43) Pub. Date: May 20, 2004

(54) Optical pickup device and its manufacturing method

(75) Inventor: Hiroaki Miyashige, Higashihiroshima-shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-Shi (JP)

(21) Appl. No.: 10/703,846

(22) Filed: Nov. 7, 2003

(30) Foreign Application Priority Data
Nov. 14, 2002 (JP) 2002-330956

(51) Int. Cl. B29D 11/00; G11B 7/135; B29C 31/00

(52) U.S. Cl. 369/112.23; 264/1.7; 264/272.11

(57) ABSTRACT

An optical pickup device includes a housing having an upper-open recess, a plurality of optical components mounted at their predetermined positions in the recess of the housing, and a resin member capable of transmitting laser light, wherein the resin member is provided for covering the optical components and fixing them at their predetermined positions in the recess.

### CROSS-REFERENCE TO RELATED APPLICATION

This application is related to Japanese Patent Application No. 2002-330956 filed on Nov. 14, 2002, whose priority is claimed under 35 USC § 119, the disclosure of which is incorporated by reference in its entirety.

### BACKGROUND OF THE INVENTION

1. Field of the Invention

The present invention relates to an optical pickup device, more particularly to an optical pickup device capable of any of reproducing information from, erasing information from and recording information to an information recording medium such as an optical disc, a magneto-optical disk or the like.

2. Description of Related Art

FIG. 3 is a schematic block diagram illustrating a conventional optical pickup device of this kind and FIG. 4 is an elevational view in section illustrating the conventional optical pickup device. In FIG. 3, dotted lines show portions of a travel path of laser light (an optical path), arrows near some of the dotted lines represent a travel direction of laser light and the arrow A represents the back-and-forth direction of the pickup device. In FIGS. 3 and 4, the arrow B represents the rotational direction, the arrow C represents the up-and-down direction and the arrow D represents the right-and-left direction of the pickup device.

The conventional optical pickup device includes a housing 100 having an upper-open recess 101 and a plurality of optical components mounted at their predetermined positions in the recess 101 using jigs Y (for example, refer to Japanese Unexamined Patent Publication No. HEI 7(1995)-201044). The plurality of optical components include at least a semiconductor laser element 1, a grating lens 2, a beam splitter 3, a collimator lens 4, a rising mirror 5, a condenser lens 6, a spot adjusting lens 7 and a light receiving element 8. The positions of the optical components are adjusted accurately in the back-and-forth direction of the arrow A, in the rotational direction of the arrow B, in the up-and-down direction of the arrow C and in the right-and-left direction of the arrow D, and the optical components are fixed on the housing 100 using bonding members and mounting members such as a pressure spring and a screw.

Hereinafter, the travel path of laser light during the use of the optical pickup device will be described.

Laser light emitted by the semiconductor laser element 1 passes through the grating lens 2, and then is reflected by the beam splitter 3 to pass through the collimator lens 4, whereby the laser light becomes collimated light. The collimated light is diffracted by the rising mirror 5, and then is converged through the condenser lens 6 to form an optical fine spot on an optical disc G. The light reflected by the optical disc G is changed again to the collimated light through the condenser lens 6, and then diffracted by the rising mirror 5 to pass through the collimator lens 4 and through the beam splitter 3. Subsequently, the light is converged through the spot adjusting lens 7 to reach the light receiving element 8. An information signal and a servo signal of the light are detected by the light receiving element 8 and the recordation and reproduction of information is performed on the basis of these signals.

However, in such a conventional optical pickup device, since the housing 100 is formed of a synthetic resin composition such as a silicon resin or an acrylic resin so as to have a thick wall for increasing the strength of the whole device, the housing is heavy in weight. Accordingly, it has been demanded that the weight of the housing be reduced while maintaining a high strength thereof. Also, though a high performance of the optical pickup device can be ensured initially owing to improvement in production environment, the pickup performance may later be decreased remarkably because foreign matters like dust may be intruded into the device depending on the variety of a use environment, and then may be attached to the optical components or may come into the optical path (particularly, a converged light path).

### SUMMARY OF THE INVENTION

The present invention has been achieved in view of the above-mentioned problems, and one major object of the present invention is to provide an optical pickup device with a high reliability, capable of reducing weight while keeping high strength, and maintaining an initially high pickup performance by preventing the entry of foreign matters into an optical path owing to a dustproof structure.

According to the present invention, there is provided an optical pickup device capable of any of reproducing information from, erasing information from and recording information to an information recording medium by use of laser light. The device comprises a housing having an upper-open recess, a plurality of optical components mounted at their predetermined positions in the recess of the housing and a resin member capable of transmitting laser light, wherein the resin member is provided for covering the optical components and fixing them at their predetermined positions in the recess.

Namely, the optical pickup device of the present invention has such a structure that the optical components accommodated at their predetermined positions in the recess are covered all together with the resin member to be fixed to the housing. Accordingly, the whole device can be increased in strength by the resin member in the recess and the use of mounting members such as a pressure spring and a screw which are conventionally required for the optical components can be eliminated. Further, since the optical components are protected by the resin member and the optical path of laser light is formed inside the resin member, a dustproof effect semipermanently lasts, and therefore the initially high pickup performance and the high reliability of the device can be ensured under any use environment.

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a schematic block diagram illustrating an optical pickup device according to an embodiment of the present invention;

FIG. 2 is an elevational view in section of the optical pickup device according to the embodiment;

FIG. 3 is a schematic block diagram illustrating an optical pickup device of prior art;

FIG. 4 is an elevational view in section of the optical pickup device of prior art.

### DESCRIPTION OF THE PREFERRED EMBODIMENTS

Examples of the information recording medium used for the optical pickup device of the present invention may be optical disks such as a LD, CD, CD-ROM, DVD-ROM, CD-R, DVD-R, CE-RW, DVD-RW and DVD-RAM, and optical-magneto disks such as a MO and MD.

According to the present invention, it is preferable that the housing is a thin-walled container with an upper opening which is composed of a basal wall and a surrounding wall. Use of the thin-walled housing makes it possible to provide a large-open recess for accommodating the optical components therein. Accordingly, the placement of the optical components in the recess and the position adjustment thereof are easily achieved. Furthermore, since the housing is thin-walled and the resin member is provided in the recess, the housing can be reduced in weight while increasing in strength in comparison with prior art housings. Also, it is preferable that a material constituting the housing is a synthetic resin composition such as a silicon resin, an acrylic resin or an epoxy resin, or light metal such as aluminum. Further, the material is preferably lightproof.

According to the present invention, examples of a material constituting a resin member may include a transparent synthetic resin composition such as a silicon resin, an acrylic resin or an epoxy resin. Among them, an epoxy resin composition having a high stiffness is preferable. In addition, a photocurable synthetic resin having a high light transmittance is preferable as the epoxy resin. The material for the resin member will be described in detail below.

According to the present invention, the resin member may be composed of a transparent resin portion which occupies at least an optical path and a lightproof resin portion which covers a surface of the transparent resin portion in order to block external light. That is, the optical components placed in the recess of the housing are covered with the transparent resin portion and the lightproof resin portion in which the external light does not pass through is stacked on the transparent resin portion to form the resin member. With this constitution, it is possible to surely prevent the entry of the external light into the resin member and the generation of stray light during the drive of the optical pickup device. The synthetic resin composition constituting the lightproof resin portion may be any obtained by mixing a silicon resin, an acrylic resin, an epoxy resin or the like with black pigments.

The plurality of optical components constituting the present optical pickup device may include at least a semiconductor laser element, a grating lens, a beam splitter, a collimator lens, a rising mirror, a condenser lens and a spot adjusting lens, but are not limited thereto and may be used in combination as required.

According to another aspect of the present invention, there is provided a manufacturing method of an optical pickup device comprising the steps of:

(a) placing optical components at their predetermined positions in an upper-open recess of a housing and adjusting the positions of the optical components,

(b) injecting a transparent resin composition into the recess before and/or after the above step (a), and

(c) curing the injected transparent resin composition to fix the optical components at their predetermined positions in the recess.

According to the manufacturing method of the present invention, the following processes 1, 2 and 3 can be given as an example.

### Process 1

(S1-1) The recess is filled with a part of the transparent resin composition to about half the depth of it (Step (b)-1) in order to form a lower layer of the resin composition. In this case, the transparent resin composition may be injected in such an amount that conventionally known jigs Y are not dipped into the transparent resin composition.

(S1-2) The optical components are placed at their predetermined positions in the recess while lower parts of the optical components are dipped into the transparent resin composition, and the positions of the optical components are adjusted in the back-and-forth direction, in the rotational direction, in the up-and-down direction and in the right-and-left direction (Step (a)). Here, the optical components can be integrated into the recess and their positions can be adjusted using the removable jigs as described above.

(S1-3) The transparent resin composition is cured in the recess to fix the optical components at their predetermined positions in the recess (Step (c)-1). If a photocurable transparent resin composition is used, the curing can be carried out by an ultraviolet irradiating machine in a short time, resulting in remarkable improvement of production efficiency. Incidentally, it is desirable to choose a transparent resin composition having the smallest possible shrinking ratio in consideration of the curing.

(S1-4) The jigs are detached from the optical components.

(S1-5) The remaining transparent resin composition is injected into the recess so as to cover the optical components (Step (b)-2), thereby to form an upper layer of the resin composition. At this time, the transparent resin composition may be injected in an amount such that at least an optical path is completely occupied by the resin composition.

(S1-6) The upper layer of the transparent resin composition is cured (Step (c)-2).

### Process 2

(S2-1) The optical components are placed at their predetermined positions in the recess using the jigs and the positions of the optical components are adjusted in the back-and-forth direction, in the rotational direction, in the up-and-down direction and in the right-and-left direction (Step (a)).

(S2-2) A part of the transparent resin composition is injected into the recess so that a substantially lower half of the optical components is dipped into the transparent resin composition (Step (b)-1), thereby to form a lower layer of the resin composition.

(S2-3) The transparent resin composition is cured in the recess to fix the optical components at their predetermined positions in the recess (Step (c)-1).

(S2-4) The jigs are detached from the optical components.

(S2-5) The remaining transparent resin composition is injected into the recess so as to cover the optical components in the recess (Step (b)-2), thereby to form an upper layer of the resin composition. At this time, the transparent resin composition may be injected in an amount such that at least an optical path is completely occupied by the resin composition.

(S2-6) The upper layer of the transparent resin composition is cured (Step(c)-2).

### Process 3

(S3-1) The optical components are placed at their predetermined positions in the recess using the jigs and the positions of the optical components are adjusted in the back-and-forth direction, in the rotational direction, in the up-and-down direction and in the right-and-left direction (Step (a)), and then the optical components are temporarily fixed at their predetermined positions in the recess using an adhesive.

(S3-2) The jigs are detached from the optical components.

(S3-3) The transparent resin composition is injected into the recess so as to cover the optical components in the recess (Step (b)). At this time, the transparent resin composition may be injected in an amount such that at least an optical path is completely occupied by the resin composition.

(S3-4) The injected transparent resin composition is cured (Step (c)).

According to the present manufacturing method of an optical pickup device, it is possible to easily manufacture an optical pickup device capable of achieving high strength, reducing weight, preventing the entry of dust and protecting the optical components. When the injection of the transparent resin composition is performed in two steps, it is preferable that an interface between the lower layer and the upper layer of the transparent resin portion is positioned so as to avoid an optical axis of laser light in consideration of the accuracy of the optical pickup device.

Further, in the present manufacturing method of an optical pickup device, the transparent resin composition is injected into the recess so as to cover the optical path in Step (b) to be cured in Step (c) and then the manufacturing method may further include the steps of:

(d) injecting a lightproof resin composition into the recess so as to cover a surface of the cured transparent resin composition, and

(e) curing the injected lightproof resin composition.

Namely, the injecting and the curing of the lightproof resin composition may be performed after the above-mentioned Processes 1, 2 and 3.

This allows the easier manufacturing of an optical pickup device which ensures the prevention of stray light generated during the drive of the device by blocking external light.

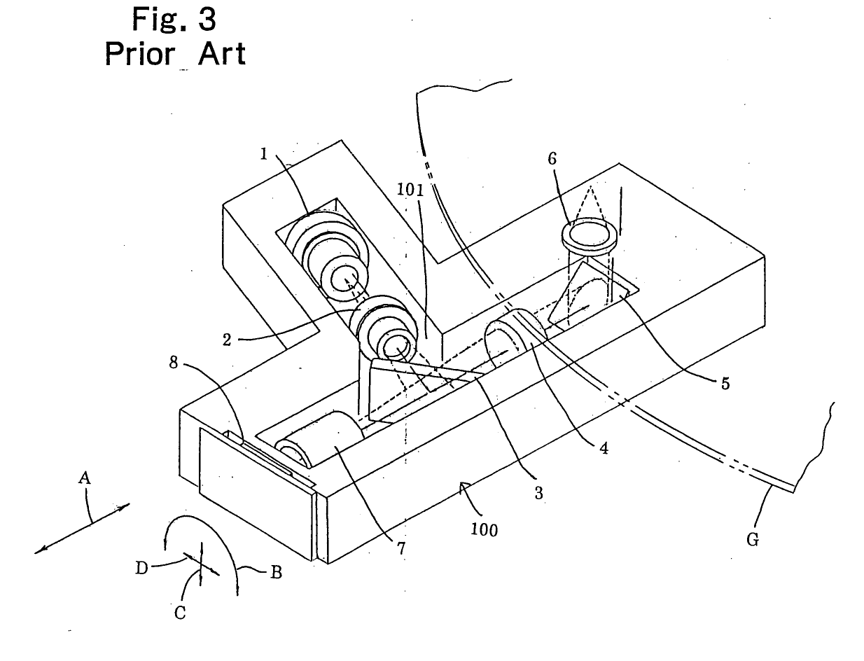

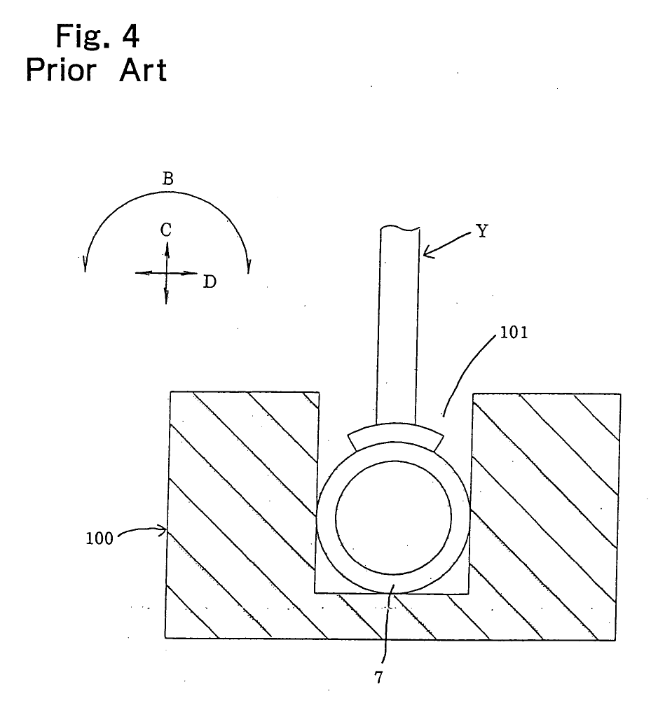

Hereinafter, the present embodiment will be described in detail with reference to the drawings, but the present invention is not limited to this embodiment. Incidentally, elements identical to those in Prior Art FIGS. 3 and 4 are represented by the same numerals.

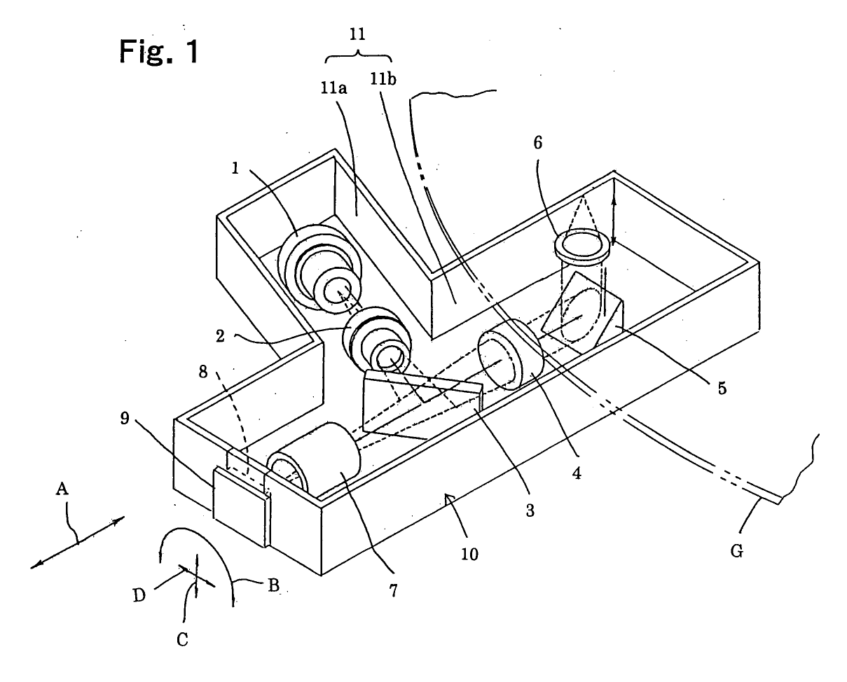

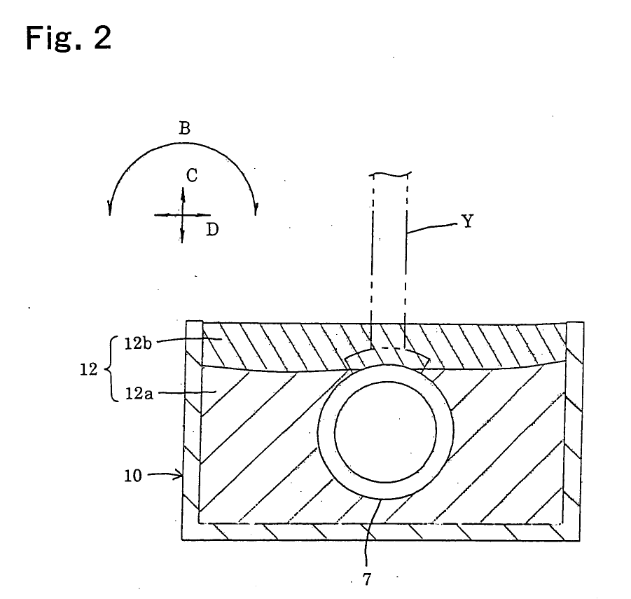

FIG. 1 is a schematic block diagram illustrating an optical pickup device according to an embodiment of the present invention and FIG. 2 is an elevational view in section of the optical pickup device according to the embodiment. The optical pickup device includes a housing 10 having an upper-open recess 11, a plurality of optical components mounted at their predetermined positions in the recess 11 and a resin member 12 capable of transmitting a laser light, wherein the resin member 12 is provided for covering the optical components and fixing them at their predetermined positions in the recess 11. The plurality of optical components include a semiconductor laser element 1, a grating lens 2, a beam splitter 3, a collimator lens 4, a rising mirror 5, a condenser lens (an objective lens) 6, a spot adjusting lens 7 and a light receiving element 8. The resin member 12 is omitted in FIG. 1.

The housing 10 is a thin-walled container having a T shape in a plan view. An inside of the housing 10 serves as the recess 11. The recess 11 is composed of a first recess 11a and a second recess 11b. The first recess 11a in a linear form accommodates the semiconductor laser element 1 and the grating lens 2, and the second recess 11b in a linear form accommodates the beam splitter 3, the collimator lens 4, the rising mirror 5 and the spot adjusting lens 7. The first recess 11a is connected almost perpendicularly to the second recess 11b at about the midpoint position along the length of the second recess 11b. The light receiving element 8 is placed at an opposed position to the spot adjusting lens 7 by, for example, fitting the element 8 into a hole provided in a wall of the housing 10 and attaching a mounting plate 9 to the wall using a screw, an adhesive or the like.

The resin member 12 is formed of a transparent resin portion 12a which covers the optical components so that at least an optical path is completely occupied by the transparent resin portion 12a and a lightproof resin portion 12b stacked thereon which blocks external light.

The transparent resin portion 12a is made of a photocurable epoxy resin having a high light transmittance. The transparent resin portion 12a is formed by injecting a transparent resin composition into the recess 11 and curing it by irradiation with an ultraviolet ray after the optical components are placed at their predetermined positions in the recess and the positions of the optical components are adjusted.

The lightproof resin portion 12b is made of a cured epoxy resin with black pigments mixed therein.

The optical components, after being placed at their predetermined positions in the recess 11, are covered all together with the transparent resin portion 12a, which ensures the formation of the optical path among the optical components. Specifically, the optical path is formed between the semiconductor laser element 1 and the grating lens 2, between the grating lens 2 and the beam splitter 3, between the beam splitter 3 and the collimator lens 4, between the collimator lens 4 and the rising lens 5, partially between the rising lens 5 and the condenser lens 6, between the beam splitter 3 and the spot adjusting lens 7, and between the spot adjusting lens 7 and the light receiving element 8. The condenser lens 6 is held above the rising lens 5 by a holder member (not shown).

According to this embodiment, the manufacturing method of an optical pickup device including the following steps S1 to S8 is given as an example.

S1: In Step (b)-1, the recess 11 of the housing 10 is filled with a part of the photocurable transparent resin composition to about half the depth of the recess 11 in order to form a lower layer of the resin composition. At this time, care should be taken not to form bubbles in the transparent resin composition.

S2: In Step (a), the optical components, i.e., the semiconductor laser element 1, the grating lens 2, the beam splitter 3, the collimator lens 4, the rising mirror 5 and the spot adjusting lens 7 are placed at their predetermined positions in the recess 11 using the jigs Y represented by a chain double-dashed line while lower parts of the optical components are dipped into the transparent resin composition. Subsequently, the positions of the optical components are adjusted in the back-and-forth direction shown by the arrow A, in the rotational direction shown by the arrow B, in the up-and-down direction shown by the arrow C and in the right-and-left direction shown by the arrow D.

S3: In Step (c)-1, the transparent resin composition is cured by irradiating it with the ultraviolet ray using an ultraviolet irradiating machine. Consequently, the optical components are fixed in the recess 11 by the cured transparent resin composition after the position adjustment is completed.

S4: The jigs Y are detached from the optical components.

S5: In Step (b)-2, the remaining transparent resin composition is injected into the recess 11 so that at least the optical path is occupied by the resin composition, thereby to form an upper layer of the resin composition.

S6: In Step (c)-2, the upper layer of the transparent resin composition is cured to form a transparent resin portion 12a.

S7: In Step (d), a lightproof resin composition is injected into the recess 11 so as to cover a surface of the transparent resin portion 12a.

S8: In Step (e), the injected lightproof resin composition is cured to form a lightproof resin portion 12b.

According to this embodiment, it is possible to obtain an optical pickup device with an excellent reliability, capable of increasing strength and reducing weight, maintaining an initially high pickup performance by preventing the entry of foreign matters into the optical path owing to a dustproof structure, and further preventing surely the generation of stray light during the drive of the device by blocking the entry of external light into the resin member 22.

### THE OTHER EMBODIMENTS

1. In the above-mentioned embodiment, the lightproof resin composition is injected into the recess 11 and then cured to form the lightproof resin portion 12b. However, a lightproof film may be attached to an upper surface of the transparent resin portion 12a instead of injecting the lightproof resin composition.

2. In the present invention, a conventional type of housing having a thick wall (see FIGS. 3 and 4) may be used and the optical components placed in a recess of the housing may be covered with the resin member.

According to the present invention, it is possible to obtain an optical pickup device with a high reliability which can achieve high strength and reduce weight, and which can maintain an initially high pickup performance by preventing the entry of foreign matters into the optical path owing to a dustproof structure.

What is claimed is:

1. An optical pickup device comprising:
a housing having an upper-open recess,
a plurality of optical components mounted at their predetermined positions in the recess of the housing, and
a resin member capable of transmitting laser light, wherein the resin member is provided for covering the optical components and fixing them at their predetermined positions in the recess.

2. The optical pickup device according to claim 1, wherein the housing is a thin-walled container.

3. The optical pickup device according to claim 1 or 2, wherein the resin member comprises a transparent resin portion which occupies at least an optical path and a lightproof resin portion which covers a surface of the transparent resin portion in order to block external light.

4. The optical pickup device according to claim 3, wherein the transparent resin portion is made of a photocurable resin composition.

5. The optical pickup device according to claim 1, wherein the plurality of optical components include at least a semiconductor laser element, a grating lens, a beam splitter, a collimator lens, a rising mirror, a condenser lens and a spot adjusting lens.

6. A manufacturing method of an optical pickup device comprising the steps of:
(a) placing optical components at their predetermined positions in an upper-open recess of a housing and adjusting the positions of the optical components,
(b) injecting a transparent resin composition into the recess before and/or after the above Step (a), and
(c) curing the injected transparent resin composition to fix the optical components at their predetermined positions in the recess.

7. The manufacturing method of an optical pickup device according to claim 6, wherein the transparent resin composition is injected into the recess so as to cover an optical path in Step (b) to be cured in Step (c) and then the method further comprises the steps of:
(d) injecting a lightproof resin composition into the recess so as to cover a surface of the cured transparent resin composition, and
(e) curing the injected lightproof resin composition.

8. The manufacturing method of an optical pickup device according to claim 6 or 7, wherein the transparent resin composition contains a photocurable resin composition and is cured by an ultraviolet irradiating machine in Step (c).
